(19) United States
(12) Patent Application Publication
(10) Pub. No.: US 2017/0069048 A1
(43) Pub. Date: Mar. 9, 2017

(54) System, Method, and Apparatus for Creating and Processing Combination Rule Sets for Licensable Properties

(71) Applicant: Glenn Barber, Irvine, CA (US)

(72) Inventor: Glenn Barber, Irvine, CA (US)

(21) Appl. No.: 15/260,303

(22) Filed: Sep. 8, 2016

Related U.S. Application Data
(60) Provisional application No. 62/215,550, filed on Sep. 8, 2015.

(51) Int. Cl. G06Q 50/18

(52) U.S. Cl. CPC G06Q 50/184

(57) ABSTRACT

Generally, in intellectual property management systems, there exists a process that performs calculations to determine and report which properties and respective rights have been granted/licensed in which territories and which properties and respective rights are available to license in which territories and for what period of time. Often, a user may be interested in the time period of availability, ownership, or sale of a property for a combination set of territories, languages, and rights. A system, method, and apparatus are provided creating and processing combination rule sets for licensable properties. The invention provides for determining the basic availability results for the property over all territory, right and language permutations specified in the combination rule set, creating all distinct combination periods from the sorted start date and end dates of each basic availability period, satisfying each distinct combination period by satisfying each rule of the combination rule set using the basic availability results, and creating a combination result set of periods for which the combination rule set is satisfied for the property.

### CROSS REFERENCE TO RELATED APPLICATIONS

This application claims priority from a provisional U.S. patent application No. 62/215,550 filed on Sep. 8, 2015.

### FIELD OF THE INVENTION

Embodiments of the invention generally relate to processing of ownership, availability and sales of licensable properties. Specifically, embodiments of the invention relate to defining and processing combination rule sets for licensable properties.

### BACKGROUND OF THE INVENTION

Owners of Intellectual Property often use an intellectual property management system to track their ownership rights and license agreements. The property rights and licenses are often stored in very large databases. Many of these systems perform complex calculations to determine and report which properties (patents, movies. books. etc.) and respective rights have been granted/licensed in which territories, and which properties and respective rights are available to license in which territories and for what period of time. This is a large multi-dimensional calculation of the availability to license of Properties, Rights, Territories, Languages and other attributes within a time period. Often, however, rights, territories, languages and other attributes for properties are sold as a combination set of grants requiring a determination of the availability to license for the entire set over a period of time.

### SUMMARY

Generally, in intellectual property management systems, there exists a process that performs calculations to determine and report which properties and respective rights have been granted/licensed. in which territories and which properties and respective rights are available to license in which territories and for what period of time. These basic availability, ownership and sale calculations are performed for each permutation of property, right, territory, and language to determine periods of time during which availability, ownership and sales exist. Often, a user may be interested in the time period of availability, ownership, or sale of a property for a combination set of territories, languages, and rights.

In accordance with the teachings of the present invention, system, method, and apparatus are provided creating and processing combination rule sets for licensable properties. The invention provides for determining the basic availability results for the property over all territory, right and language permutations specified in the combination rule set, creating all distinct combination periods from the sorted start date and end dates of each basic availability period, satisfying each distinct combination period by satisfying each rule of the combination rule set using the basic availability results, and creating a combination result set of periods for which the combination rule set is satisfied for the property. The basic availability results can be determined by retrieving from a database of prior calculated availability results or by calculating availability results using a basic availability calculation process. First, the combination rule set may be expanded to establish each territory, right and language permutation in the combination rule set. Last, contiguous periods of combination result sets of the same type can be concatenated. Further the combination result set can stored in a database or outputted to the user.

### BRIEF DESCRIPTION OF THE DRAWINGS

The accompanying drawings taken in conjunction with the detailed description will assist in making the advantages and aspects of the disclosure more apparent.

FIG. 1 is a database table layout for a license and its property grants.

FIG. 2 is a database table layout for a combination rule set definition

FIG. 3 is a database table layout for a ownership, availability and sale results

FIG. 4 is a flowchart of how the combination rule set is processed to create a combination result set.

FIG. 5 is a block diagram of a general system embodiment on a single computer.

FIG. 6 is a block diagram of an alternative system embodiment on multiple computers.

### DETAILED DESCRIPTION

Reference will now be made in detail to the present embodiments discussed herein, illustrated in the accompanying drawings. The embodiments are described below to explain the disclosed system, apparatus, and method by referring to the Figures using like numerals. It will be nevertheless be understood that no limitation of the scope is thereby intended, such alterations and further modifications in the illustrated device, and such further applications of the principles as illustrated therein being contemplated as would normally occur to one skilled in the art to which the embodiments relate.

The subject matter is presented in the general context of system and program modules that are able to read and write data to memory, databases, or similar. Those skilled in the art will recognize that other implementations may be performed that may include different data structures, components, or routines that perform similar tasks. The invention can be practiced using various computer system configurations, such as client server systems. Other usable systems can include, but are not limited to, mainframe computers, microprocessors, personal computers, smart phones, tablets, and other consumer electronic devices. Such computer devices may include one or more processors, data storage in the form of memory (hard disk, random access memory, cache memory, etc.), a database, and an OS.

System, method and apparatus for creating and processing combination rule sets for licensable properties are provided. This invention shall apply to licensable intellectual property and the determination and reporting of which property licenses have been granted and which property rights are still available to license. In intellectual property management systems, availability, ownership and sale calculations are commonly performed for each permutation of property, right, territory, and language to determine periods of time during which availability, ownership and sales exist. These are basic availability, ownership, and sales calculations for a property, which are hereinafter referred to as “basic availability” calculations, where a basic availability period is the period from a start date to an end date of basic availability.

Often, a user may be interested in the time period of availability, ownership, sales of a property for a combination set of territories, languages, and rights. For example, a user would like to know when Title A is available in both the continental United States and Puerto Rico territories, in English and Spanish language, for Pay TV and Free TV rights. Rather than reporting the individual periods of availability for each permutation of territory, language and right, it would be desirable to report only those periods of time where the entire combination rule set has been satisfied. This is important because often a new license requires that the entire set of territories, languages and rights be available to license together at the same time. This invention allows for the definition of combination rule sets and a process to determine the periods of time during which the entire combination rule set is satisfied, resulting in the creation of a combination result set.

A combination rule set is a set of requirements and rules that must be entirely satisfied within a time period. These requirements include, but are not limited to, types of availability/sales, territories, rights, languages, and exclusivity restrictions. By satisfying the requirements of the entire combination rule set over contiguous periods of time, a timeline for a combination result set can be created.

For example, a combination rule set requires availability in United States in Pay TV and Free TV. If the basic availability records have been calculated as “Available in the United States of Pay TV from Jan. 1, 2015 to Dec. 31, 2015” and “Available in the United States of Free TV from Jun. 1, 2015 to Dec. 31, 2015.” The combination of the basic availability records satisfies all of the requirements of the combination rule set to create a combination result set for Jun. 1, 2015 to Dec. 31, 2015.

The acquisition of property rights and sale of property rights are generally entered into a system by a user on a license by license basis. Typically a license is stored as a license header with general license information and the license grants identifying the properties, rights, territories and languages granted over a period of time.

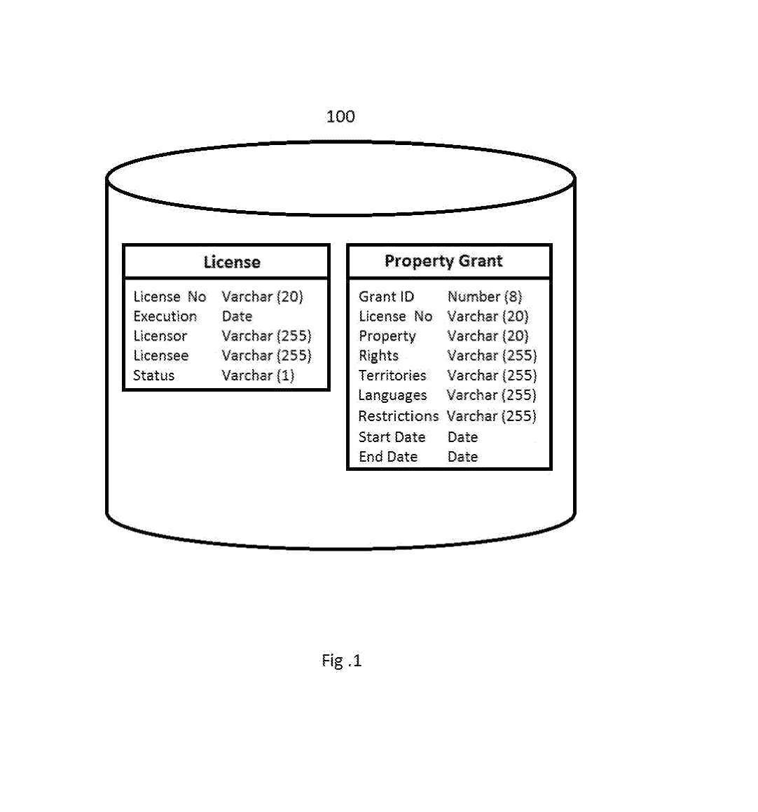

As illustrated in FIG. 1, a database table layout 100 of the License Header and Property Grant tables is provided.

A license can be stored as a license header and the grants in separate tables. A typical license header table includes a License No, a unique key identifying the license. Other relevant data for a license can include the license execution date, licensor and licensee. A status identifying a license as pending, executed, terminated or any other relevant status is also common.

In a separate subordinate table, a typical Property Grant table includes a Grant ID, a unique key for each row, and a License No referring back to the license header table. Each row contains a single property, a list of rights granted, a list of territories in which the grants occur, languages in which the property is granted, and other restrictions such as exclusivity. Lastly, a grant would typically include the start and end date of the grant period. Other database layouts could add additional columns, known to those in licensing, such as authorized uses and formats to replace or supplement the rights column.

This database layout stores the license header information separately from the grants. This database layout illustrates that grants of properties are distinct from grants of other properties and can be stored in such a way. Other database table layouts may vary by depicting the grants over additional tables for different rights, territories, languages and the like.

A combination rule set can be entered into a system by a user. The combination rule set can be stored as a set header and the set detail identifying the rights, territories, languages, other restrictions, and avail types in the set.

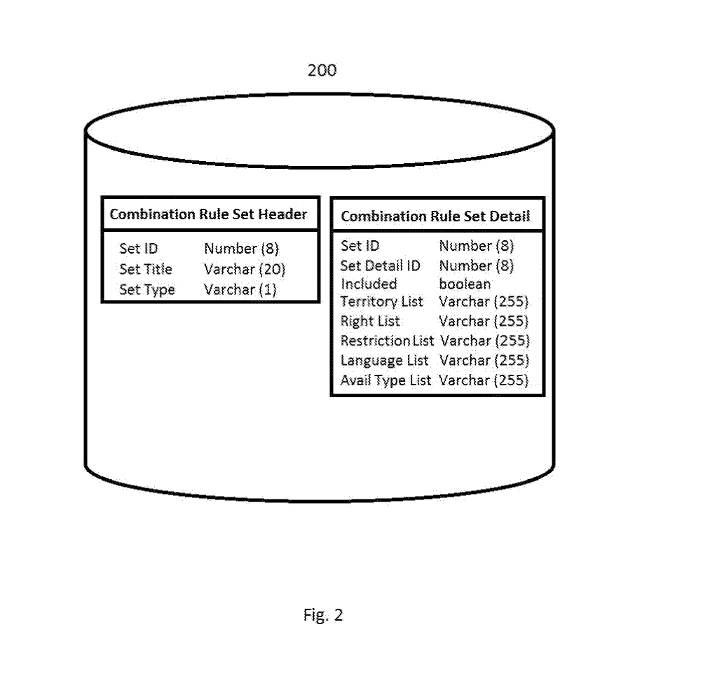

As illustrated in FIG. 2, a database table layout 200 of the combination rule set and combination rule set detail tables is provided.

A combination rule set can be stored as a combination rule set header and the combination rule set detail in separate tables, though other database layouts may combine some of the elements into a single table. The combination rule set header table can include a Set ID, a unique key identifying the combination rule set. A user would likely want a Set Title made up of readable text that allows the user to easily identify the set for editing and selection. A Set Type can identify variations in how combination rule sets may be entered and calculated.

The combination rule set detail table includes a Set Detail ID, a unique key for each row, and a Set ID referring back to the Combination rule set header table. Each row contains an Included Flag which indicates whether the row detail is required to satisfy the combination rule set or must not exist to satisfy the rule. A set detail row contains a list of rights and/or a list of territories in which the grants occur. A list of languages can be specified, and can also include the selection of “All Languages” and “Any Language.” Other combination rule sets layouts could add additional columns, known to those in licensing, such as authorized uses and formats to replace or supplement the rights column. The Restriction column allows the user to specify other types of licensing restrictions. These can include exclusivity used in the calculation, such as Exclusive, Non-exclusive, First Run, and Co-exclusive. Avail Type list allows a user to define which Availability, Sale, or Ownership types are required for the rule. Availability types can include Available, Available as a Placeholder and Available for Holdback. Sale types can include Sale, Option or Holdback. A combination rule set consists of one or more combination rule set detail records.

The database layout identifies a combination rule set as a more than one territory, right, language permutation. The permutation rule, to be included, must be satisfied by the identified type, which can include the availability type or an exclusivity restriction.

This database layout stores rights, territories, languages, restrictions and avail types as lists for easier user entry. Each list must be expanded/multiplied to create the unique right/territory/language/exclusivity/avail type permutations that must be continuously satisfied during the entire period. Other database table layouts may vary, requiring a user to manually enter each permutation that makes up combination rule set. Further, other database layouts may lack some of the detail items such as restriction and avail type.
A sample combination rule set is provided:
Set ID: 5 Set Title: “United States TV Rights” Set Type: ‘G’ (General)
A sample combination rule set detail is provided:
Set Detail ID: 8 Set ID: 5 Include: true Rights List: “Pay TV, Free TV”
Territory List: “United States, Puerto Rico” Languages: “English, Spanish”
Restrictions: “Exclusive, Non-exclusive” Avail Type: “Available”
   This sample combination rule set is titled “United States TV Rights.” To satisfy the set, United States AND Puerto Rico, Pay TV AND Free TV, English AND Spanish, are required to be Available, Exclusively OR Non-exclusively.

In the preferred embodiment, some rules in the combination rule set are defined as an OR condition. For example, Restrictions allows the specification of “Exclusive OR Non-exclusive”. The condition is satisfied by an exclusivity of either Exclusive or Non-exclusive. Avail Type can also be defined as an OR condition.

Storing the combination rule set in a database allows for easy retrieval and calculation of multiple combination rule sets for multiple properties as needed. In other embodiments, a user can enter a combination rule set for a single immediate calculation without saving the combination rule set to a database. A data structure similar to the combination rule set layout 200 can be used for calculating and manipulating data entered by the user.

Management of combination rule sets can be done via a combination rule set entry interface. Such an interface can also be used to enter multiple combination rule sets, select previously entered combination rule sets, and identify a list of properties to be processed. In other embodiments, the selection of which combination rule sets and properties to process can be automated, based on recent licensing activity or other changes to the rights management system. Once the combination rule sets and properties are defined/selected, the interface can allow the user to initiate processing, either manually or upon completed entry/definition of a combination rule set. In other embodiments, the processing of combination rule sets can occur upon certain events such as license activity or can be programmed to occur daily.

In the preferred embodiment, basic availability calculation results are calculated and stored in a database. Then, predefined combination rule sets are processed using the basic availability results and the combination result sets are generated and stored in the database as well. Storing results of both basic availability and combination result sets in a database table allows for efficient retrieval for the purpose of calculation, reporting, and additional analysis.

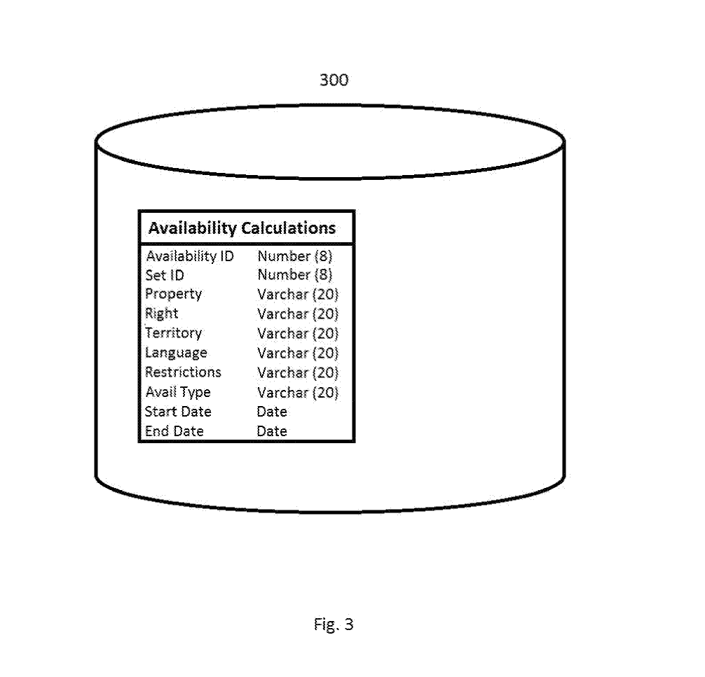

As illustrated in FIG. 3, a database table layout 300 of the availability calculation table is provided.

Availability calculations for basic availability and combination result sets can be stored in a single table. The availability calculation table can include an Availability ID, a unique key identifying the availability result. A Set ID can refer back to the Combination rule set table identify those results derived from a combination rule set. For basic availability calculation, to which there is no combination rule set reference, a ‘0’ or some other default value can be set in the Set ID field. For basic availability calculation, each row contains a property, a right, a territory, and language for which the calculation was performed. For combination result sets, the property is specified, but the rights, territory, and language fields may be blank or filled with some value, such as “Multi” indicating that that there are multiple rights, territories or languages in the combination result set. The Set ID referring back to the Combination rule set identifies which rights, territories and languages apply. Restrictions can include, but are not limited to, the type of exclusivity calculated, such as Exclusive and Non-exclusive. Avail Type identifies if the results are a form of Availability, Sale, or Ownership types calculated. Availability types may include Available, Available with a Placeholder and Available for Holdback. Sale types may include Sale, Option or Holdback. Lastly, the availability results table would include the start and end date of the period for the availability or sale.

In alternative embodiments, both basic availability calculations and the combination rule set calculations are performed at run time and reported immediately. In such embodiments, rather than a database table, a similarly designed data structure for manipulation and calculation can be used. In other embodiments, basic availability calculations are performed at an earlier time and only basic availability results are stored in the database for later retrieval. Later, the combination rule set is defined and calculated at run time and reported. Embodiments will vary in when combination rule sets are defined and when calculations are processed and whether they are stored in a database for future reporting or immediately reported.

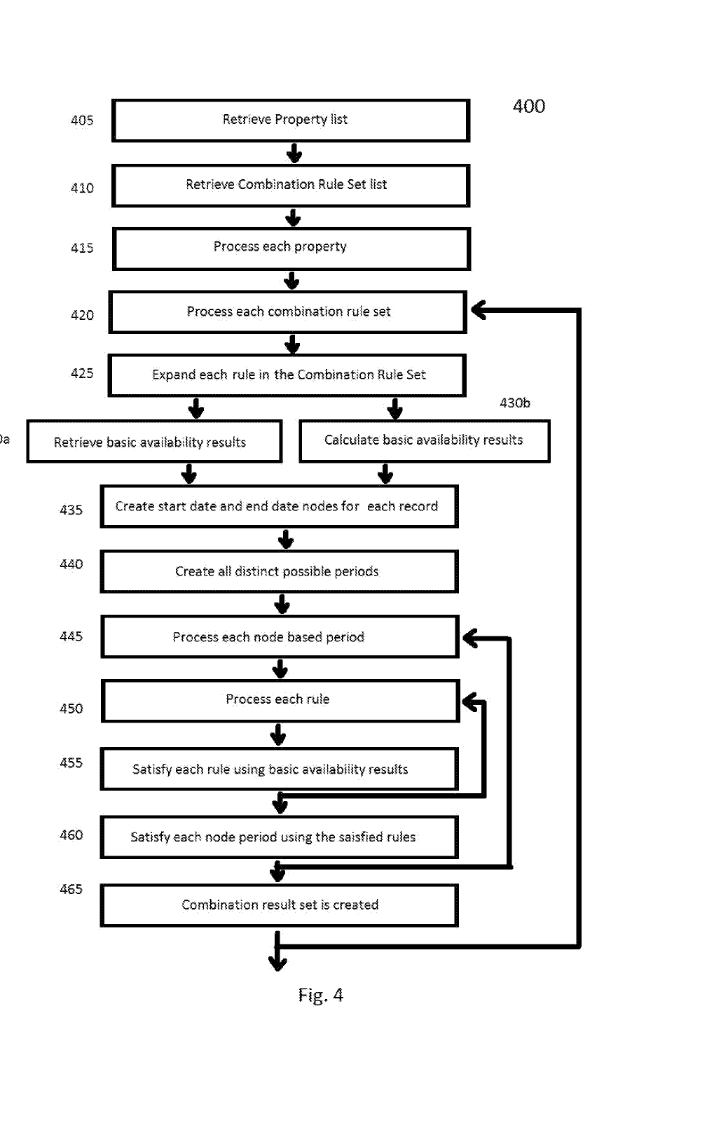

As illustrated in FIG. 4, a flowchart 400 of how combination rule sets are processed to create combination result sets for all license properties is provided.

The lists of all properties to be processed and all combination rule sets to be processed are retrieved 405. In embodiments where predefined combination rule sets are stored in a database, the list of all combination rule sets to be processed is retrieved 410. Alternatively, the user manually enters a combination rule set to be processed. For each property 415, each combination rule set will be processed 420.

In an embodiment where the combination rule set layout 200 (or manual user entry layout) contains lists of territories, rights, languages, other restrictions and avail types, the lists must be expanded and multiplied to create unique cross product combinations 425.

To process a combination rule set, basic availability calculations must be performed for each discrete property, right, territory and language permutation in the combination rule set. This results in the determination of the availability and/or sales in the property, right, territory and language permutation. In some embodiments this occurs just prior to the processing of each combination rule set and then is filtered for the specified avail type and restriction in the combination rule set 430a. Alternatively, in the preferred embodiment, basic availability calculations have been created in advance and stored in a table. The basic availability results are retrieved from an availability results table 300 for each property, right, territory, language, restriction and avail type permutation 430b. These are the relevant basic availability records that will be used to process the combination rule set.

Each basic availability record represents a period with a start date and end date during which availability type and exclusivity for a property, territory, right and language combination are consistent for the period. When any aspect of that availability changes (or becomes non existent), a new availability period is required. For the combination rule set, where availability must be satisfied over multiple rights and/or territories, multiple basic availability records must be examined that may have varying and overlapping start date and end date periods. The calculation can be simplified by defining a new set of smaller distinct periods for calculation, created from the sorted of list of start and end dates from the basic availability records, such that no period has a start date or end date of a basic availability fall within it.

From each record basic availability record, two date nodes are created: a start date node and an end date node 435. These date nodes identify the dates that are significant to the combination rule set because they are either the start date or and end dates for a period of availability. The date nodes from all of the basic availability records are sorted by ascending date order. The date nodes are used to create all distinct possible periods for which the combination rule set can be satisfied 440. A combination result set will be calculated for each of these node based combination periods.

For example, basic availability records of Jan. 1, 2015 to Jan. 1, 2016, Jun. 1, 2015 to Jan. 1, 2017 and Jan. 1, 2016 to Jan. 1, 2017 will result in the distinct nodes for Jan. 1, 2015, Jun. 1, 2015, Jan. 1, 2016 and Jan. 1, 2017 as the key dates in which availability starts or ends. This will result in distinct possible combination result set periods of Jan. 1, 2015 to Jun. 1, 2015, Jun. 1, 2015 to Jan. 1, 2016 and Jan. 1, 2016 to Jan. 1, 2017.

For each node based combination period, the process attempts to satisfy the requirements of the combination rule set 445. This is done by satisfying each rule in the expanded combination rule set within that period by checking against the basic availability results in that period to determine if the condition is satisfied in that period 450. If satisfied, the expanded combination rule is marked as satisfied for that period 455. If the entire expanded combination rule set is marked as satisfied, then the node based combination period is marked satisfied 460, and the next node combination period is processed. This process results in a list of start and end date periods for the combination result set that have been marked as satisfying or not satisfying the requirements of the combination rule set 465.

Processing the combination rule set for each node based period is provided:
For each node based combination period

For each expanded combination rule set item
If satisfied by a basic availability result then
   Mark expanded combination rule set item as satisfied
Else
   Mark expanded combination rule set item as not satisfied
End if

Next

If the entire combination rule set is marked as satisfied then
Mark the nodes based combination period as satisfied

Else
Mark the nodes based combination period as not satisfied

End if
Next

When different elements of an OR set are used to satisfy a rule, the result set can identify which conditions were used to satisfy the rule. For example when a rule specifies a Restriction of “Exclusive or Non-exclusive,” the result set can identify whether the rule is satisfied by Exclusive, Non-exclusive or a mixture of the two. This is similarly done for Avail Type.

Any contiguous start and end date periods for the combination result set that have been marked as satisfying the requirements of the combination rule set continuously during the period can be concatenated to create a larger period with the start date of the earlier period and the end date of the earlier period. This can only be done if the period type (Restriction and Avail Type) of the contiguous periods are the same. For example, a combination result set of periods Available Exclusively Jan. 1, 2015 to Dec. 31, 2015 and Available Exclusively Jan. 1, 2016 to Dec. 31, 2016 can be combined to create a period of Available Exclusively Jan. 1, 2015 to Dec. 31, 2016. However, a combination result set of periods Available Exclusively Jan. 1, 2015 to Dec. 31, 2015 and Available Non-exclusively Jan. 1, 2016 to Dec. 31, 2016 cannot be combined

The combination result sets for each property can be stored in the availability results table 300 with the Set Id identifying which combination rule set the combination result set was derived from. These results can later be retrieved for reporting of the results from the combination rule set. Alternatively, the results can be immediately reported without storing the results in a database. The process continues until each combination rule set for each property is processed.

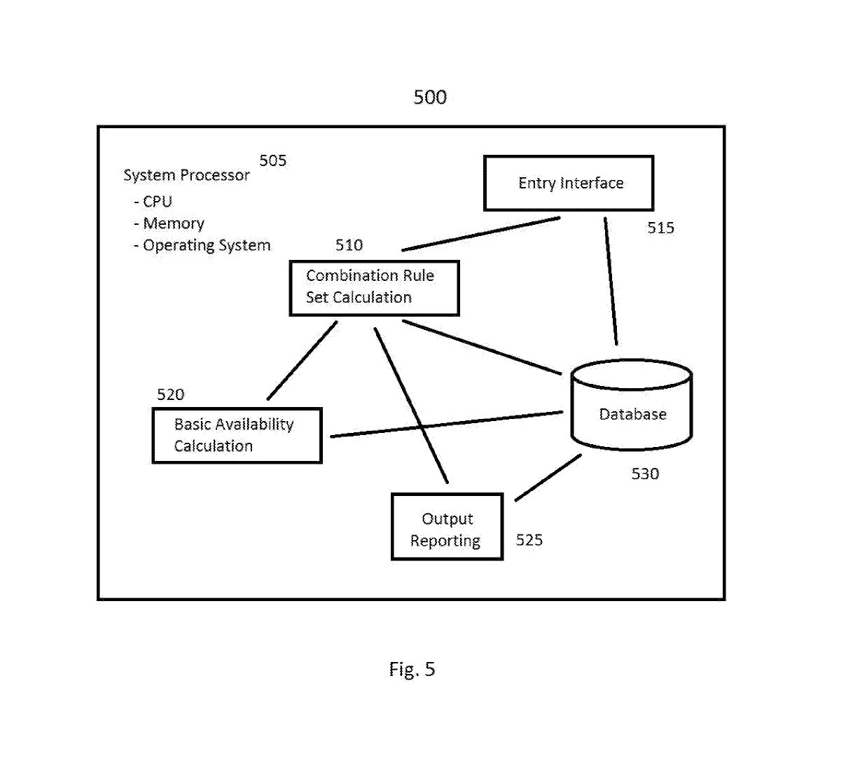

As illustrated in FIG. 5, a block diagram 500 of a general system embodiment on a single computer device, is provided.

In a general system embodiment, one System Processor 505 performs all processes. Some components of the computer include one or more processing units, memory (hard disk, random access memory, cache memory, etc.), an OS, and a database 510. The System Processor 505 is configured to processes combination rule sets 510, the selection of which combination result sets and which properties to process can be determined by varying means. An entry interface 515 can allow for the entry of combination rule sets which can be written to the database 530 or used for immediate processing. The entry interface can support selection or definition of multiple combination rule sets, processing of multiple properties, and can be used to initiate the start of processing. The System Processor can be configured to process basic availability calculations 520 or can merely retrieve basic availability results from a database 530. Embodiments can vary between a system that performs basic calculations immediately prior to performing combination rule set calculations and a system that retrieves basic calculation results from a database 530 immediately prior to performing combination rule set calculations 510. In some embodiments, combination result sets (retrieved from the database or immediately after processing) can be manipulated and outputted to the user 525 in various ways the can be readily understood by user such as timelines, graphs, or other tables.

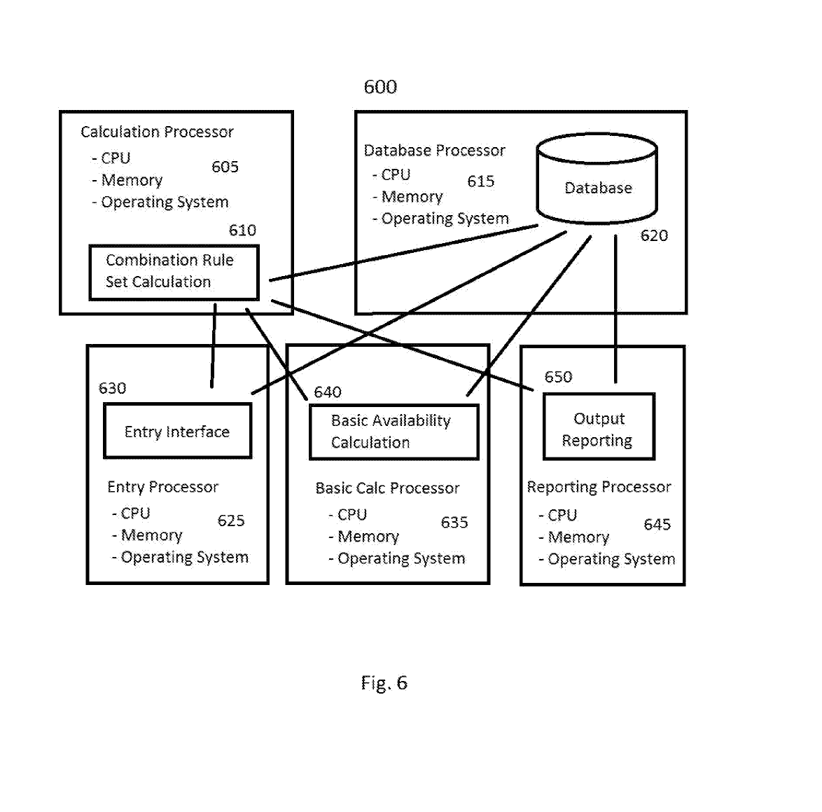

As illustrated in FIG. 6, a block diagram 600 of a general system embodiment across multiple computer devices, is provided.

In a system embodiment over a network, multiple computers 605, 615, 625, 635, 645 perform all processes. Some components of the computers include one or more processing units, memory (hard disk, random access memory cache memory, etc.), an OS, network connectivity, and a commonly accessible database. The Calculation Processor 605 is configured to processes combination rule sets 610, the selection of which combination result sets and which properties to process can be determined by varying means. The Database Processor 615 contains the database 620 which is read from and written to by the other processors performing calculations, entry and reporting. The Entry Processor 625 is configured with an entry interface 630 that allows for the entry of combination rule sets which can be written to the database 620 or used for immediate processing. The entry interface 630 can support selection or definition of multiple combination rule sets, processing of multiple properties, and can be used to initiate the start of processing. The Basic Calc Processor 635 can be configured to process basic availability calculations 640, where the results can be stored in the database or fed directly to the Calculation Processor 605. Embodiments can vary between a system that performs basic calculations immediately prior to performing combination rule set calculations and a system that retrieves basic calculation results from a database 620 immediately prior to performing combination rule set calculations 610. The A Reporting Processor 645 can be configured to use combination result sets (retrieved from the database or immediately after processing) and manipulate and output them to the user 650 in various ways the can be readily understood by user such as timelines, graphs, or other tables.

It should noted that many systems utilizing multiple computers can be implemented. Fox example, the entry interface could be contained on the same computer as the database. The basic availability processing and combination rule set processing can occur on the same computer.

The preceding description contains embodiments of the invention and no limitation of the scope is thereby intended.

That which is claimed is:

1. A computer implemented method for processing a combination rule set for a licensable property:
determining the basic availability results for the property over all territory, right and language permutations specified in the combination rule set;
creating all distinct combination periods from the sorted start date and end dates of each basic availability period;
satisfying each distinct combination period by satisfying each rule of the combination rule set using the basic availability results;
creating a combination result set of periods for which the combination rule set is satisfied for the property.

2. The method of claim 1, wherein the basic availability results are determined by retrieving from a database of prior calculated availability results.

3. The method of claim 1, wherein the basic availability results are determined by calculating using a basic availability calculation process.

4. The method of claim 1 further comprising:
firstly, expanding each rule in the combination rule set to establish each territory, right and language permutation in the combination rule set.

5. The method of claim 1 further comprising:
lastly, concatenating any contiguous periods of combination result sets of the same type.

6. The method of claim 1 further comprising:
lastly, storing the combination result set in a database.

7. The method of claim 1, further comprising:
lastly, outputting the combination result set to the user.

8. A system for processing a combination rule set for a licensable property comprising at least one processor, the at least one processor configured to cause the system to at least perform:
determining the basic availability results for the property over all territory, right and language permutations specified in the combination rule set;
creating all distinct combination periods from the sorted start date and end dates of each basic availability period;
satisfying each distinct combination period by satisfying each rule of the combination rule set using the basic availability results;
and creating a combination result set of periods for which the combination rule set is completely satisfied for the property.

9. The system of claim 8, wherein the basic availability results are determined by retrieving from a database of prior calculated availability results.

10. The system of claim 8, wherein the basic availability results are determined by calculating availability results using a basic availability calculation process.

11. The system of claim 8 further comprising:
firstly, expanding each rule in the combination rule set to establish each territory, right and language permutation in the combination rule set.

12. The system of claim 8 further comprising:
lastly, concatenating any contiguous periods of combination result sets of the same type.

13. The system of claim 8 further comprising:
lastly, storing the combination result set in a database.

14. The system of claim 8, further comprising:
lastly, outputting the combination result set to the user.

15. An apparatus for managing a combination rule set for licensable properties comprising:
an entry interface for defining a combination rule sets for availability processing, allowing for the entry of:
a) more than one territory, right, language permutation;
b) period type which can include availability type or exclusivity restriction to satisfy the rule;
and a means for initiating the processing of combination rule sets

16. The apparatus of claim 15 further comprising:
a database for the storage of combination rule sets.

17. The apparatus of claim 15 further comprising:
means of access to a database for the storage of combination rule sets.

18. The apparatus of claim 15 wherein the processing of combination rule sets is manually initiated by the user.

19. The apparatus of claim 15 wherein the processing of combination rule sets is initiated upon a new or changed combination rule sets.

20. The apparatus of claim 15, where in the processing of combination rule sets is regularly scheduled.
